(19) United States
(12) Patent Application Publication
(10) Pub. No.: US 2007/0290004 A1
(43) Pub. Date: Dec. 20, 2007

(54) Liquid dispenser having multiple outlets

(75) Inventors: Yi-Lung Lee, Taichung County (TW); Chin-Sung Lin, Taichung County (TW); Zhen-Hua Chou, Hualien County (TW)

Correspondence Address: BROWDY AND NEIMARK, P.L.L.C.;624 NINTH STREET, NW, SUITE 300, WASHINGTON, DC, 20001-5303, US

(73) Assignee: Antera Biotech Corp., Taichung city (TW)

(21) Appl. No.: 11/653,990

(22) Filed: Jan. 17, 2007

(30) Foreign Application Priority Data
Jun. 15, 2006 (TW) 95121496

(51) Int. Cl. B65D 88/54; B67D 5/08; B01L 3/02

(52) U.S. Cl. 222/330; 222/52; 422/63; 422/100

(57) ABSTRACT

A liquid dispenser includes a dispenser body having a liquid input passage extending inwardly from the top side of the dispenser body, a liquid distribution passage formed inside the dispenser body in communication with the liquid input passage, two liquid output passages each having a first side respectively connected to the liquid distribution passage and a second side provided with a plurality of outlets, and an air output passage in communication with the liquid output passages. A plurality of needle cannulas are respectively fastened to a bottom side of the dispenser body and respectively connected to the outlets of the liquid output passages. When liquid is filled inside the dispenser body, the air initially contained inside the dispenser body will be forced by the liquid to be discharged out of the dispenser body through the air output passage.

### BACKGROUND OF THE INVENTION

1. Field of the Invention

The present invention relates generally to liquid dispensers for use in biochemical analyzers and more specifically, to a liquid dispenser having multiple outlets for use in a biochemical analyzer, which can dispense liquid out of the outlets equally.

2. Description of the Related Art

In a biochemical analyzer a liquid dispenser is used to dispense the prepared liquid, for example catalyst solution, from a supply tube to multiple needle cannulas, enabling an equal amount of the prepared liquid to be respectively outputted from the needle cannulas to respective containers (or wells) in the biochemical analyzer.

However, because the aforesaid liquid dispenser directly dispenses the prepared liquid from the supply tube to a plurality of needle cannulas, for example eight needle cannulas, the output amount of the needle cannulas may be not equal due to the effect of pressure difference thereamong. Unequal supply of the prepared liquid to the containers (or wells) results in an inaccurate examination or test result. Further, air may be accumulated in the passage in the liquid dispenser. Accumulation of air in the liquid dispenser will also affect the dispensing accuracy.

### SUMMARY OF THE INVENTION

The present invention has been accomplished under the circumstances in view. It is one objective of the present invention to provide a liquid dispenser, which dispenses the supplied liquid accurately to all terminals at an equal amount.

To achieve this objective of the present invention, the liquid dispenser comprises a dispenser body and a plurality of needle cannulas. The dispenser body has a top side, a bottom side opposite to the top side; a liquid input passage extending inwardly from the top side of the dispenser body to a predetermined depth, a liquid distribution passage formed inside the dispenser body in communication with the liquid input passage, at least one liquid output passage formed inside the dispenser body with a first side in communication with the liquid distribution passage and a second side provided with in a plurality of outlets, and an air output passage formed in the dispenser body and extending inwardly from the top side of the dispenser body to a predetermined depth in communication with the at least one liquid output passage. The needle cannulas are respectively fastened to the bottom side of the dispenser body. The needle cannulas each have a first end respectively connected to the outlets of the at least one liquid output passage and a second end suspending outside the bottom side of the dispenser body. When liquid is filled inside the dispenser body, the air initially contained inside the dispenser body will be forced by the liquid to be discharged out of the dispenser body through the air output passage, such that the liquid fully filled inside the dispenser body can be dispended out of the dispenser body through the needle cannulas at an equal amount.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a perspective view of a liquid dispenser according to a preferred embodiment of the present invention;

FIG. 2 is a sectional view taken along line 2-2 of FIG. 1;

FIG. 3 is a sectional view taken along line 3-3 of FIG. 1;

FIG. 4 is schematic drawing showing that the liquid dispenser of the present invention is connected with a pump and a control valve;

FIG. 5 is a schematic drawing showing an operation status of the liquid dispenser according to the present invention;

FIG. 6 is another schematic drawing showing an operation status of the liquid dispenser according to the present invention, and

FIG. 7 is still another schematic drawing showing an operation status of the liquid dispenser according to the present invention.

### DETAILED DESCRIPTION OF THE INVENTION

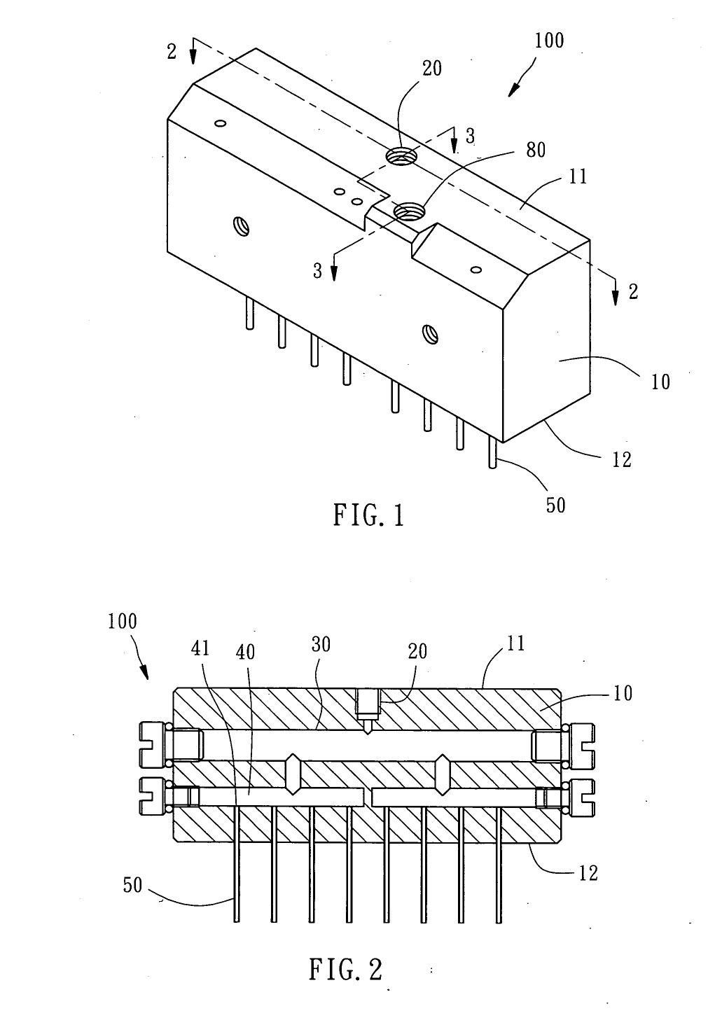

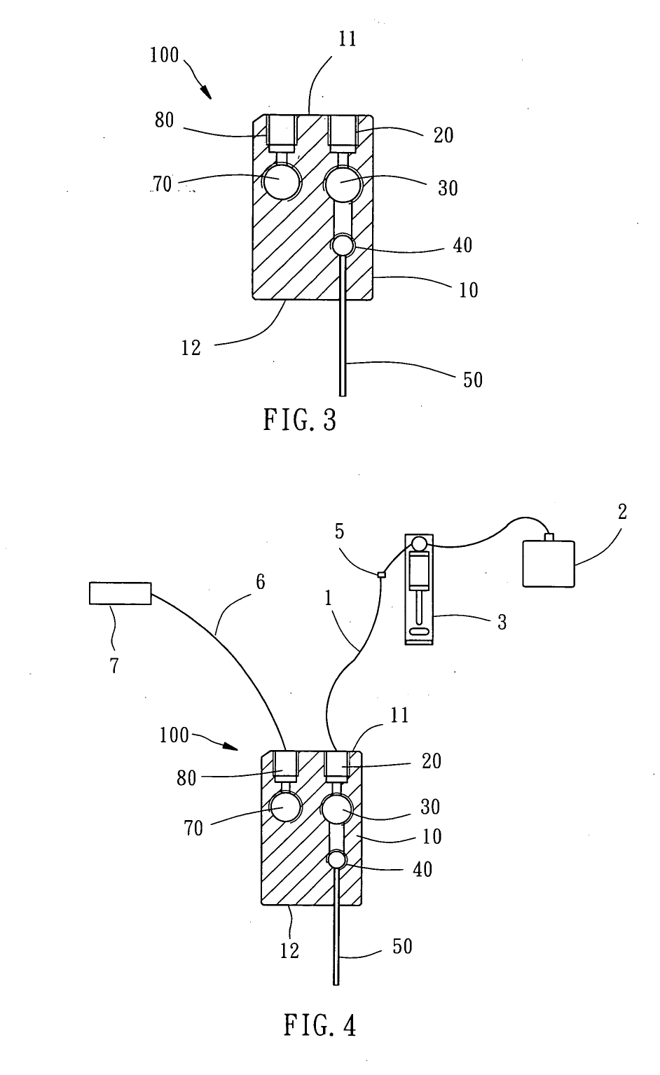

As shown in FIGS. 1-3 and FIG. 7, a liquid dispenser 100 in accordance with a preferred embodiment of the present invention comprises a dispenser body 10 having a liquid input passage 20, a liquid distribution passage 30, two liquid output passages 40, four air distribution passages 60, an air accumulation passage 70, and an air output passage 80, and eight needle cannulas 50.

The dispenser body 10 has a top side 11 and a bottom side 12 opposite to the top side 11.

The liquid input passage 20 extends downwards from the top side 11 of the dispenser body 10 to a predetermined depth.

The liquid distribution passage 30 is formed inside the dispenser body 10, having its middle part in liquid communication with the bottom end of the liquid input passage 20.

The two liquid output passages 40 are respectively formed inside the dispenser body 10, each having one lateral side respectively in liquid communication with the liquid distribution passage 30 and the opposite side provided with four outlets 41.

The eight needle cannulas 50 are respectively fastened to the bottom side 12 of the dispenser body 10, each having a top end respectively connected to the outlets 41 of the liquid output passages 40 and a bottom end suspending below the bottom side 12 of the dispenser body 10.

The four air distribution passages 60 are formed inside the dispenser body 10 and arranged in two pairs respectively connected to the two liquid output passages 40.

The air accumulation passage 70 is formed inside the dispenser body 10 in air communication with the four air distribution passages 60.

The air output passage 80 extends downwards from the top side 11 of the dispenser body 10 to a predetermined depth and disposed in air communication with the air distribution passages 60.

After understanding of the structure of the liquid dispenser 100, the operation of the liquid dispenser 100 is described hereinafter:

Referring to FIG. 4, a liquid tube 1 is connected with its one end to the liquid input passage 20 and its opposite end to a liquid container (for example, catalyst solution container) 2 through a power unit (for example, pump) 3. As shown in FIG. 4, the power unit 3 is connected between the liquid tube 1 and the liquid container 2 and operable to deliver liquid 4 from the liquid container 2 to the dispenser body 10 of the liquid dispenser 100 through the liquid tube 1. Further, a sensor 5 is installed in the liquid tube 1 near the pump 3 and adapted to detect flowing of the liquid 4 through the liquid tube 1 and to output a control signal at a predetermined length of time after detection of flowing of the liquid 4 through the liquid tube 1. Further, an air tube 6 is connected with its one end to the air output passage 80 and its opposite end to a control valve 7 that is controllable to close/open the air tube 6.

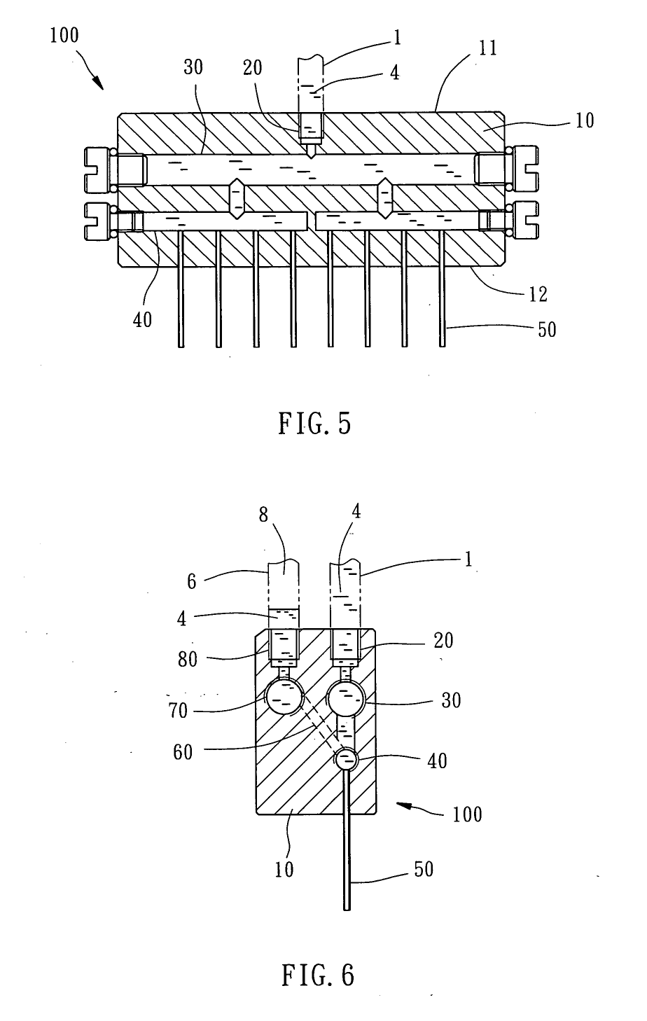

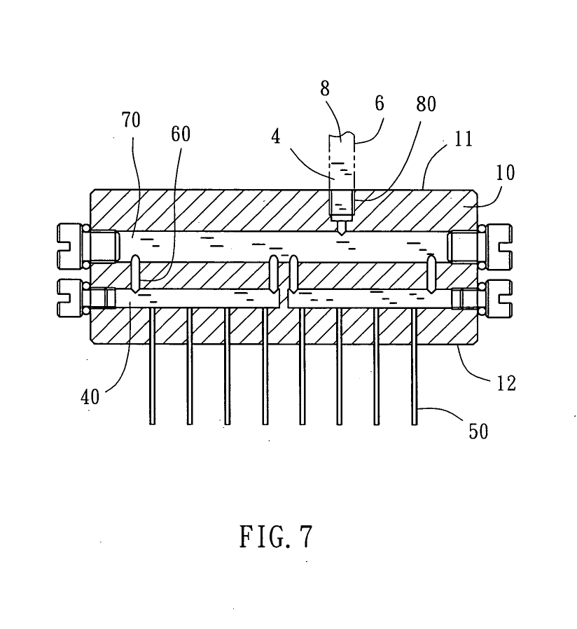

During operation, the control valve 7 is operated to open the air tube 6, and then the power unit 3 is operated to deliver the liquid 4 from the liquid container 2 to liquid input passage 20 in the dispenser body 10 of the liquid dispenser 100 through the liquid tube 1. At this time, the liquid 4 flows from the liquid input passage 20 to the liquid distribution passage 30 and the two liquid output passages 40 (see FIG. 5). Because the inner diameter of the needle cannulas 50 is quite small, the pressure of the liquid 4 in the dispenser body 10 of the liquid dispenser 100 is insufficient to force the liquid 4 out of the needle cannulas 50 at this time, and the continuous input flow of the liquid 4 goes from the liquid output passages 40 to the 4 air distribution passages 60, the air accumulation passage 70 and the air output passage 80 (see FIG. 7), and therefore the dispenser body 10 of the liquid dispenser 100 is fully filled up with the liquid 4 (see FIGS. 5 and 6). At this time, air 8 is expelled out of the dispenser body 10 of the liquid dispenser 100 into the liquid tube 6 (see FIGS. 6 and 7). When the predetermined dispensing time is up, the sensor 5 controls the control valve 7 to close the air tube 6, thereby increasing the pressure of the dispensed liquid 4 to force the liquid 4 out of the needle cannulas 50 at an equal amount.

What is claimed is:

1. A liquid dispenser comprising:
a dispenser body having a top side, a bottom side opposite to the top side, a liquid input passage extending inwardly from the top side to a predetermined depth, a liquid distribution passage formed inside the dispenser body in communication with the liquid input passage, at least one liquid output passage formed inside the dispenser body in communication with the liquid distribution passage and provided with a plurality of outlets, and an air output passage extending inwardly from the top side of the dispenser body to a predetermined depth in communication with the at least one liquid output passage, and
a plurality of needle cannulas respectively fastened to the bottom side of the dispenser body, the needle cannulas each having a first end respectively connected to the outlets of the at least one liquid output passage and a second end suspending outside the bottom side of the dispenser body.

2. The liquid dispenser as claimed in claim 1, wherein the dispenser body further comprised a plurality of air distribution passages respectively connected to the at least one liquid output passage, and an air accumulation passage in air communication between the air distribution passages and the air output passage.

3. The liquid dispenser as claimed in claim 1, further comprising a liquid container and a liquid tube connected between the liquid container and the liquid input passage for guiding liquid from the liquid container to the liquid input passage.

4. The liquid dispenser as claimed in claim 3, further comprising a power unit, which is in communication with the liquid container and the liquid tube and controllable to force the liquid out of the liquid container into the liquid tube and the liquid input passage.

5. The liquid dispenser as claimed in claim 3, further comprising a sensor installed in the liquid tube adapted to detect flowing of the liquid out of the liquid container into the liquid tube and to output a control signal at a predetermined length of time after detection of flowing of the liquid through the liquid tube.

6. The liquid dispenser as claimed in claim 1, further comprising an air tube connected to the air output passage, and a control valve controllable to close and open the air tube.
